(19) United States
(12) Patent Application Publication
(10) Pub. No.: US 2023/0243683 A1
(43) Pub. Date: Aug. 3, 2023

(54) FLOWMETER AND METHOD FOR MEAUSURING THE FLOW OF A FLUID

(71) Applicants: Markus KLEMM, Waldkirch (DE); SICK ENGINEERING GMBH, Ottendorf-Okrilla (DE)

(72) Inventor: Markus KLEMM, Waldkirch (DE)

(21) Appl. No.: 18/011,902

(22) PCT Filed: Jun. 24, 2021
(86) PCT No.: PCT/IB2021/055607

§ 371 Date: Dec. 21, 2022

(30) Foreign Application Priority Data
Jul. 16, 2020 (EP) 20186143.2

(51) Int. Cl. G01F 1/667; G01F 1/66; G01P 5/24

(52) U.S. Cl. CPC G01F 1/668; G01F 1/662; G01P 5/245; G01P 5/241

(57) ABSTRACT

A flowmeter for measuring a flow of a fluid has a sensing element that has a pipeline for the fluid with a pipe wall, at least one phased array ultrasonic transducer unit, which can emit ultrasonic signals into different emission angles and can receive ultrasonic signals from different reception angles, a control and evaluation unit that is designed to control the ultrasonic transducer unit for emitting the ultrasonic signals along a measurement path and for evaluating the received ultrasonic signals and determining a flow using transit times of the ultrasonic signals. The sensing element has at least one reflector, which is designed to reflect the ultrasonic signals emitted by the ultrasonic transducer unit back to the same ultrasonic transducer unit. The ultrasonic signals pass through the measurement path from the ultrasonic transducer unit to the reflector and back to the ultrasonic transducer unit on at least partially different path sections.

The invention relates to a flowmeter and a method for measuring the flow of a fluid based on ultrasound.

Different measurement principles are known for determining the flow or flow rate or the flow of a fluid based on ultrasound.

In a differential transit time method, a pair of ultrasonic transducers is mounted on the outside circumference of the pipeline with a mutual offset in the longitudinal direction, which alternately emit and register ultrasonic signals transverse to the flow along a measurement path spanned between the ultrasonic transducers. The ultrasonic signals transported through the fluid are accelerated or decelerated by the flow, depending on the transit direction. The resulting transit time difference is calculated with geometric variables to form a mean flow rate of the fluid. Using the cross sectional area, this results in the volume flow or flow rate. For more accurate measurements, multiple measurement paths can also be provided, each with a pair of ultrasonic transducers to detect a flow cross section at more than one point. For a high measurement accuracy for asymmetrical velocity distributions over the flow cross section, multiple measurement paths are required, which do not run through the pipe axis or the center axis of the pipeline, so-called non-diametrical measurement paths or secant paths. In particular, far off-center secant paths are desirable for high insensitivity of the volumetric flow measurement compared to inhomogeneous flow distributions.

The ultrasonic transducers used to generate the ultrasound have an oscillating body, often a ceramic. With its aid, an electrical signal is converted into ultrasound, for example, based on the piezoelectric effect, and vice versa. Depending on the application, the ultrasonic transducer operates as a sound source, sound detector or both. Coupling between the fluid and the ultrasonic transducer must be ensured. A common solution is to allow the ultrasonic transducers to protrude into the line with direct contact with the fluid. Such intrusive probes can make precise measurements more difficult due to disruption of the flow. Conversely, the immersed ultrasonic transducers are exposed to the fluid and its pressure and temperature and are thus potentially damaged or lose their function due to deposits.

In principle, techniques in which the inner wall remains completely closed are also known. One example is the so-called clamp-on assembly, for example according to U.S. Pat. No. 4,467,659, with which the ultrasonic transducers are fastened from the outside to the pipeline. In this way, however, only diametrical measurement paths can be realized through the pipe axis, whereby additional errors are generated for flow profiles that are not axially symmetrical.

A further embodiment is presented in DE 10 2013 101 950 A1, in which the ultrasound units themselves each consist of groups of several individual transducers. In the case of multi-layer pipe walls made of fiber composite materials, for example, these can be directly integrated into the pipe wall. The functional principle uses the transducer groups to emit or receive targeted ultrasound through structure-borne sound waves, as in classic clamp-on arrangements. This has the advantage, as known by so-called clamp-on constructions, in which the ultrasonic transducers are mounted on the outside of the channel wall, that the transducer unit does not protrude into the flow channel and thus the flow is not disturbed, and no contamination can occur.

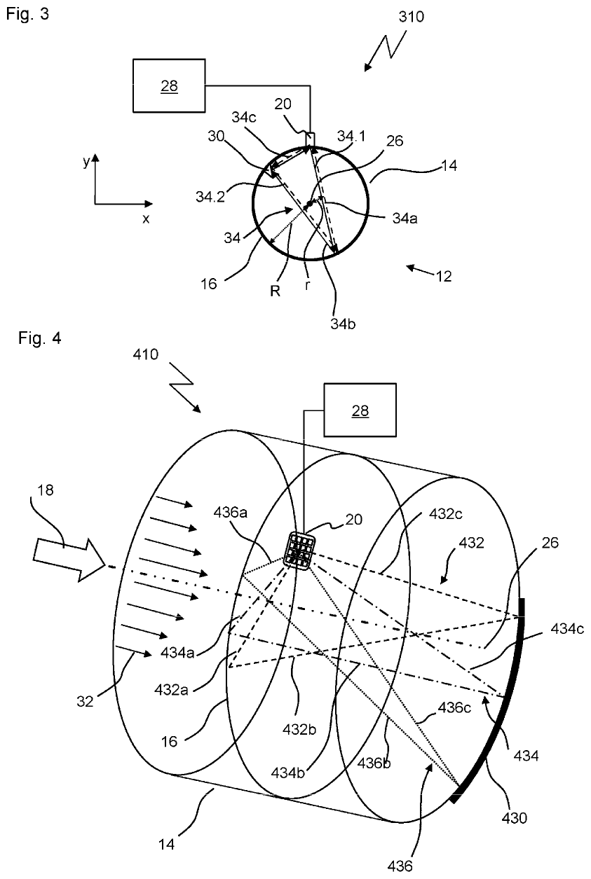

A further disadvantage with known intrusive probes occurs at high flow rates. This is illustrated clearly in EP 2 103 912 A1 in FIGS. 3 and 4. Due to the drift effect, the ultrasonic package strikes different spots on the opposite pipe wall depending on the flow velocity and possibly no longer strikes the ultrasonic transducer unit arranged there.

From Kang et al. “Two-dimensional flexural ultrasonic phased array for flow measurement” in 2017 IEEE International Ultrasonics Symposium (IUS), Washington, D.C., USA, 6-9 Sep. 2017. Published in: 2017 IEEE International: Ultrasonics Symposium (IUS) ISSN 1948-5727 is known to counter the above-mentioned drift effect by so-called “phased array beam steering”. A “phased array” consists of individual ultrasonic transducers, which together emit ultrasonic signals in superposition, the emission direction of which can be changed by changing the individual phases of the individual signals. These “phased array” ultrasonic transducer units are used in openings of a flow channel.

A disadvantage of the differential transit time methods known from the prior art is that at least two ultrasonic transducer units are required for each measurement path. In addition, reciprocal electronics or complete symmetry, that is, exactly identical behavior of the ultrasonic transducer units and the connected electronics for the back and forth direction, is necessary, which further increases the complexity of the device.

Furthermore, a Doppler method determining the flow or stream rate is known. Here, the frequency shift of an ultrasonic signal that is reflected within the flowing fluid and varies depending on the flow rate is evaluated. In this case, only one ultrasonic transducer emitting and receiving the ultrasonic signals is used. However, a measurement is only possible when sufficient scattering particles are present in the fluid that reflect the ultrasonic signal.

Document US 2015/0020608 A1 describes a flowmeter with an arrangement of ultrasonic transducer elements, which is configured to activate a first sub-arrangement of the arrangement of ultrasonic transducer elements to direct at least two outgoing ultrasonic beams through a fluid, and to activate a second sub-arrangement of the arrangement of ultrasonic transducer elements to detect the ultrasonic beams after passing through a measurement path. However, only diametrical measurement paths extending through a pipe center axis are disclosed, which span a measurement plane in which the pipe center axis is also located. In the case of non-axially symmetrical flow profiles, such diametrical measurement paths result in inaccurate measurement results, since the flow profile is only insufficiently detected over the cross section.

Proceeding from this prior art, it is the object of the invention to provide an improved device for measuring the flow rate, which is suitable for measuring fluids which do not contain any or only a small number of scattering particles, wherein the device has reduced technical complexity and can provide improved measurement accuracy for non-axially symmetrical flow profiles.

This object is achieved by a flowmeter having the features of claim 1 and a method for measuring the flow of a fluid having the features of claim 12.

The flowmeter according to the invention comprises

a sensing element having a pipeline with a pipe wall for the fluid,
at least one phased array of ultrasonic transducer unit, wherein a phased array ultrasonic transducer unit in connection with this application comprises ultrasonic transducer units capable of emitting ultrasonic signals into different angles and capable of receiving ultrasonic signals from different angles, in particular also arrangements of only two ultrasonic transducers,
a control and evaluation unit, which is designed to control the ultrasonic transducer unit for transmitting the ultrasonic signals along a measurement path, for evaluating the received ultrasonic signals and for determining a flow using transit times of the ultrasonic signals, wherein
the sensing element has at least one reflector, which is designed to reflect the ultrasonic signals emitted by the ultrasonic transducer unit back to the ultrasonic transducer unit, wherein the ultrasonic signals pass through the measurement path from the ultrasonic transducer unit to the reflector and back to the ultrasonic transducer unit on at least three different path sections, and the measurement path is a secant path not extending diametrically through a center axis of the pipeline.

The particular advantage of the invention is that the flowmeter according to the invention requires only one ultrasonic transducer unit for determining a flow of a fluid by means of difference transit time methods and provides improved measurement accuracy even for non-axially symmetrical flow profiles. The elimination of the usually necessary second ultrasonic transducer unit significantly reduces the complexity of the flowmeter.

In one embodiment, the flowmeter according to the invention can be designed such that the ultrasonic transducer unit is a one-dimensional ultrasonic transducer unit having a one-dimensional linear array of ultrasonic transducers. Since the emission angle of the ultrasonic signal with a one-dimensional ultrasonic transducer unit can only be changed in one plane and the ultrasonic signal can be emitted and received again in this plane, the ultrasonic transducer unit and the reflector are aligned such that the ultrasonic signals, after reflection at the reflector and the pipe wall, again strike the ultrasonic transducer essentially in the plane in which they were emitted. In this case, “essentially” means that the one-dimensional ultrasonic transducer unit can have an acceptance angle at which ultrasonic signals can also be received, which do not strike the ultrasonic transducer unit directly in the plane of the emitted ultrasonic signals. Such an acceptance angle is typically in the range of +/−10 degrees to a nominal transmit and receive plane of a one-dimensional ultrasonic transducer unit, wherein the nominal transmit and receive plane is referred to as the plane into which the ultrasonic signals are emitted and in which the efficiency for receiving ultrasonic signals is highest. In a one-dimensional ultrasonic transducer unit with a row-shaped arrangement of the ultrasonic transducers, this is generally a plane which comprises the ultrasonic transducer row and the radiation direction of the ultrasonic signals.

The ultrasonic signals are first reflected by a first reflector in a first measurement after emission by the one-dimensional ultrasonic transducer unit and strike a second reflector, which reflects the ultrasonic signals back to the ultrasonic transducer unit. The ultrasonic signals therefore pass through a measurement path which has at least three different path sections, namely from the ultrasonic transducer unit to the first reflector, from the first reflector to the pipe wall and from the pipe wall back to the ultrasonic transducer unit, wherein the reflector and the ultrasonic transducer unit are matched and aligned so that the measurement path is a secant path, the raw center axis is therefore not located in a plane spanned by the measurement path, but only intersects it at one point. As described above, a received ultrasonic signal can be in a nominal transmit and receive plane of the ultrasonic transducer unit or can have an angle relative to the nominal transmit and receive plane that is at most as large as an acceptance angle of the ultrasonic transducer unit. The measurement path can also have further path sections, wherein the measurement signal can be reflected at further reflectors and/or on the pipe wall. It is essential that the emitted ultrasonic signals received again after passing through the measurement path lie essentially in one plane.

For differential measurement, the ultrasonic transducer unit is further designed to emit ultrasonic signals in a second measurement in such a way that they pass through the measurement path in the reverse direction, that is, initially from the ultrasonic transducer unit to the second reflector, from the second reflector to the first reflector and from the first reflector back to the ultrasonic transducer unit. From the difference of the transit times of the ultrasonic signals determined in the two measurements, the evaluation unit can calculate a mean flow rate of the fluid in a known manner.

In a development of this embodiment, the flowmeter according to the invention can be designed such that a plurality of measurement paths is realized within the measurement plane, wherein the ultrasonic signals can be emitted and received within the measurement plane at different angles. Preferably, a reflector can then be provided for each measurement path.

In an alternative embodiment, the flowmeter according to the invention can be designed such that the ultrasonic transducer unit is a two-dimensional ultrasonic transducer unit having a two-dimensional array of ultrasonic transducers, wherein the individual ultrasonic transducers of the ultrasonic transducer unit can preferably be arranged in rows and columns. This provides greater flexibility with respect to the possible measurement paths. In particular, measurement paths formed with a two-dimensional array as secant paths can be realized in different measurement planes. Since the measurement paths are designed as secant paths, in this embodiment the raw center axis also does not lie in the measurement planes spanned by the measurement paths, but only intersects them each at one point.

The ultrasonic signals are initially reflected at least once by the pipe wall of the pipeline in a first measurement after the emission by the ultrasonic transducer unit. After one or multiple reflections on the pipe wall, the ultrasonic signals strike a reflector, which reflects the ultrasonic signals back to the ultrasonic transducer unit. The ultrasonic signals therefore pass through a measurement path that has at least three different path sections, namely from the ultrasonic transducer unit to the pipe wall, from the pipe wall to the reflector and from the reflector back to the ultrasonic transducer unit. For more than one reflection on the pipe wall, the measurement path also has path sections from pipe wall to pipe wall.

For differential measurement, the ultrasonic transducer unit is further designed to emit ultrasonic signals in a second measurement in such a way that they pass through the measurement path in the reverse direction, that is, initially from the ultrasonic transducer unit to the reflector, from the reflector to the pipe wall and after one or multiple reflections at the pipe wall back to the ultrasonic transducer unit. From the difference of the transit times of the ultrasonic signals determined in the two measurements, the evaluation unit can calculate a mean flow rate of the fluid in a known manner.

In the configuration of the ultrasonic transducer unit as a two-dimensional ultrasonic transducer unit, it can emit and receive ultrasonic signals in different measurement planes. For this purpose, the sensing element can have a plurality of reflectors arranged on or in the pipe wall. Alternatively, the sensing element can have a reflector arranged in an arc-shape in or on the pipe wall and the ultrasonic transducer unit can be controlled such that the ultrasonic signals strike the arcuate reflector at different locations. As a result, different measurement paths can be used flexibly. The reflector can also be designed to be circular, that is, to cover the entire inner circumference of the pipe wall, whereby the number of possible measurement paths is further increased.

It is particularly advantageous in both described embodiments if, at least for one path section, the ratio r/R is between 0.3 and 0.65, wherein R is the radius of the pipeline and r is the shortest distance of the path section from the center axis of the pipeline. These path sections are particularly well situated to scan the flow in a meaningful way. They are off-center with regard to the pipe axis but not too close to the edge. The paths then also lie approximately on Gaussian nodes. This is advantageous because in the Gaussian node the flow profile does not change with the velocity of the fluid. Overall, the result is a higher measurement accuracy. To further improve measurement accuracy, at least two path sections can have different values for the r/R ratio.

In a preferred embodiment of the flowmeter according to the invention, the path section between the ultrasonic transducer unit and the reflector extends at a path angle of less than 20 degrees, particularly preferable less than 15 degrees to the center axis of the pipeline. This has the advantage that the ultrasonic signal extends in an area close to the pipe wall and is less influenced by the flow of the fluid on this path section than in the area of the center axis of the pipeline, since flow profiles of fluid flows in pipelines generally have a significantly lower flow rate in the area of the pipe wall than in the area of the center axis of the pipeline.

The ultrasonic transducer unit can advantageously be integrated into the pipe wall of the pipeline. As a result, the flow of the fluid is not influenced and undesired disturbances, for example due to turbulence, are prevented.

The reflector or reflectors can preferably be arranged downstream of the ultrasonic transducer unit in the flow direction, so that they do not influence the fluid flow in the area between the ultrasonic transducer unit and the reflectors.

In one embodiment of the invention, the ultrasonic transducer unit and/or the reflector can be arranged in a recess of the pipe wall for reducing disturbances of the fluid flow. In this embodiment, the recess can preferably be at least partially concealed. Particularly preferable are then only openings for entry and exit of the ultrasonic signals.

Since the ultrasonic transducer unit is designed as a phased array, it can emit ultrasonic signals at a first angle and receive them at a second angle different from the first angle. The ultrasonic transducer unit can be aligned such that ultrasonic signals are emitted at an angle equal in magnitude and received again after passing through the measurement path. The further processing of the reception data is simplified by such a symmetry.

In one embodiment of the invention, the ultrasonic transducer unit can be designed as a linear array consisting of a row of at least two ultrasonic transducers whose orientation is parallel to the measurement path. This makes it possible to counteract a drift effect by controlling the ultrasonic transducers with respect to their phase and thus tracking the radiation angle correspondingly. Thus, better measurement results can be acquired over a wide range of flow rates. The phased array ultrasonic transducer unit can then account for the drift effect online and adjust the direction of the emission of the ultrasonic packets to the flow rate.

The ultrasonic transducer unit can also be designed to emit ultrasonic signals at different emission angles simultaneously and to receive the reflected ultrasonic signals simultaneously at different reception angles, wherein the received ultrasonic signals can either be separated from one another by digital post-processing, and the difference in transit time can thus be determined or the interference of the received ultrasonic signals can be evaluated and the difference in transit time can be determined from the signal image.

If a sufficient number of particles is present in the fluid in order to carry out the Doppler measurement mentioned at the beginning to determine the flow rate, the flowmeter according to the invention can also be designed to carry out both methods to achieve a higher accuracy in the determination of the flow rate.

The method according to the invention can be developed in a similar manner and shows similar advantages. Such advantageous features are described by way of example but not conclusively in the dependent claims following the independent claims.

The invention is explained in detail below by way of exemplary embodiments with reference to the drawing. In the drawings:

FIG. 1 shows a schematic illustration of a flowmeter;

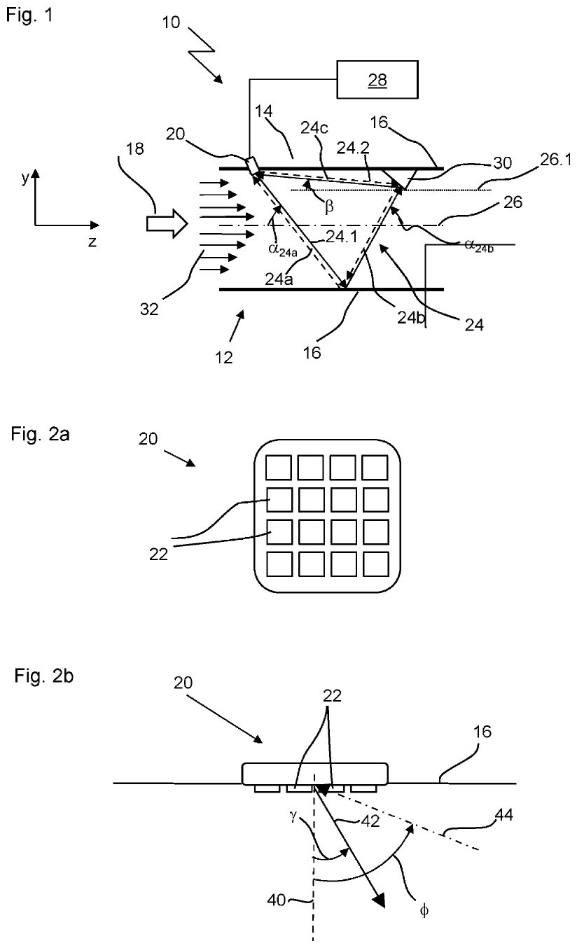

FIG. 2a shows a schematic plan view of an ultrasonic transducer unit designed as a two-dimensional array;

FIG. 2b shows a schematic side view of an ultrasonic transducer unit designed as a two-dimensional array;

FIG. 3 shows a schematic illustration of a flowmeter according to the invention;

FIG. 4 shows a schematic perspective illustration of a flowmeter according to the invention;

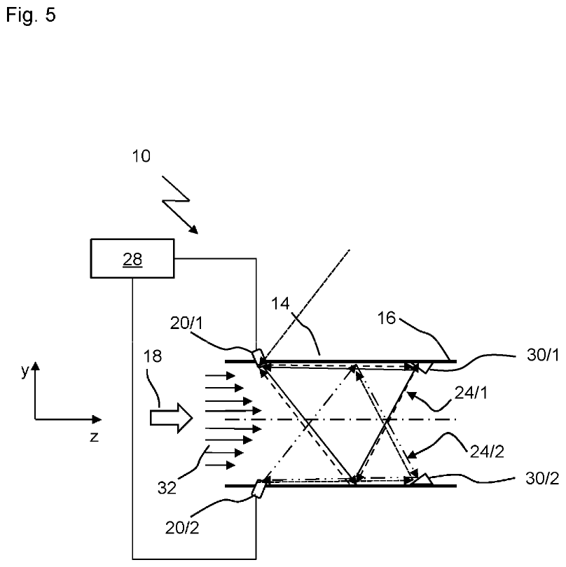

FIG. 5 shows a schematic illustration of an alternative embodiment of a flowmeter according to the invention for multi-path measurement;

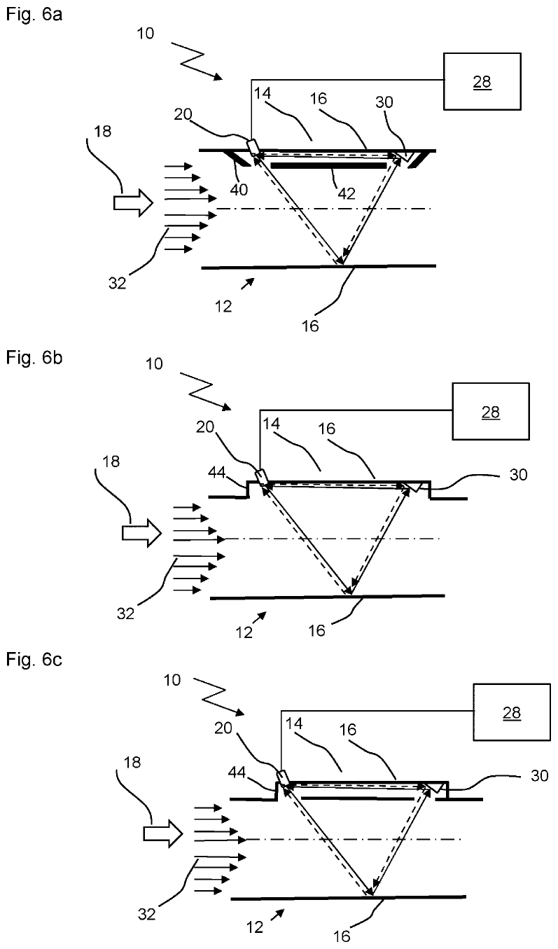

FIGS. 6a-6c show schematic illustrations of shields of a measurement path in a flowmeter according to the invention;

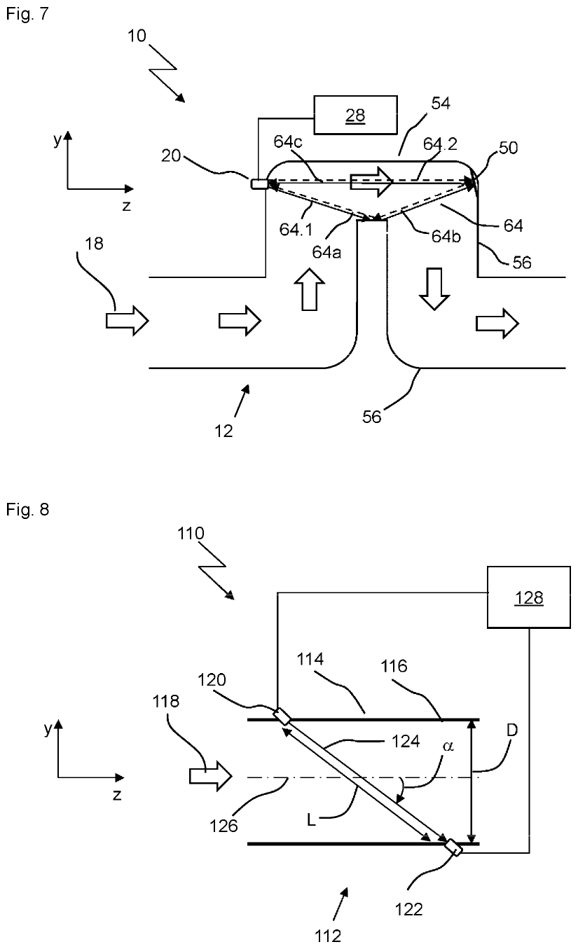

FIG. 7 shows a schematic illustration of a further embodiment of the flowmeter according to the invention;

FIG. 8 shows a schematic illustration of a flowmeter according to the prior art;

FIG. 8 is a flowmeter 110 according to the prior art for general explanation of the function of a generic flowmeter. The flowmeter 110 comprises a sensing element 112, which has a pipeline 114 for the fluid 118 with a pipe wall 116. The fluid flowing through the pipeline 114, a gas or a liquid, is illustrated in FIG. 8 with a wide arrow and flows in the z-direction along a center axis 126 of the pipeline 114.

Furthermore, the flowmeter 110 has two ultrasonic transducers 120 and 122, which define a measurement path 124 therebetween in the pipeline 114. The ultrasonic transducers 120 and 122 are arranged offset in the flow direction z, that is, spaced apart in the longitudinal direction along the center axis 126 of the pipeline 114. As a result, the measurement path 124 is not orthogonal to the flow direction z, but instead at a path angle α. Each of the ultrasonic transducer units 120 and 122 can operate as a transmitter or receiver and is controlled by a control and evaluation unit 128.

The path angle α and the pipe diameter D result in the length L of the measurement path 124 in the fluid medium. Ultrasonic signals which are emitted and received as ultrasonic wave packets on the measurement path 124 in opposite directions thus have one component once in the direction of the flow direction z and another time counter to the flow direction z, and are thus accelerated with the flow of the fluid 118, or decelerated, respectively, against the flow. The mean flow rate v of the fluid is calculated in this runtime method according to

$$v = \frac{\frac{{t}_{2} - {t}_{1}}{2 * {t}_{2} ⋆ {t}_{1}} * L}{cos ( α )}$$

where t₂ and t₁ denote the sound transit times, which are required by the emitted ultrasonic wave signals to cover the measurement path 124 upstream or downstream, respectively, and are detected in the control and evaluation unit 128. With the pipe cross section and the mean flow rate v of the fluid 118, the flow can then be calculated.

The flowmeter 10 also operates according to this principle, which is illustrated very schematically in FIG. 1. It also has a sensor element 12 with a pipeline 14 and pipe wall 16 and a control and evaluation unit 28. The fluid 18 flowing through the pipeline 14, a gas or a liquid, is illustrated using a wide arrow and flows in the z-direction along a center axis 26 of the pipeline 14. The flowing fluid 18 has a flow profile 32, which has little influence on ultrasonic signals propagating along the pipe wall 16, for example due to a lower flow rate of the fluid 18 in the area of the pipe wall 16, compared to a flow rate in the area of the center axis 26.

In contrast to the flowmeter 110, from FIG. 8, the device for measuring a flow of a fluid in FIG. 1 has only one ultrasonic transducer unit 20 in the pipe wall 16. The ultrasonic transducer unit 20 is also not a “simple” ultrasonic transducer, but is designed as a phased array ultrasonic transducer unit 20. It can be designed as a one-dimensional linear array consisting of a row of at least two individually controllable ultrasonic transducers, whose orientation is parallel to the measurement path 24, or as shown in the schematic plan view of FIG. 2a, as a two-dimensional array of individually controllable ultrasonic transducers 22. The individual ultrasonic transducers 22 are controlled for emitting an ultrasonic signal by the control and evaluation unit 28, such that that they each have a phase offset from one another, wherein the phase offset is selected such that superposition of the resulting ultrasonic waves leads to an ultrasonic wave signal which leaves the ultrasonic transducer unit 20 at an emission angle γ perpendicular to a surface normal 40 of the ultrasonic transducer unit 20, as shown in FIG. 2b, in which the emitted ultrasonic wave signal is represented by a solid line 42. The ultrasonic transducer unit 20 can further be controlled such that ultrasonic wave signals which strike the ultrasonic transducer unit 20 at an incidence angle ϕ (illustrated by the dash-dotted line 44 in FIG. 2b) are detected. Emission angle γ and incidence angle ϕ can differ both in magnitude and direction. The mode of operation of such phased array ultrasonic transducer units is known from the prior art.

FIG. 2a illustrates an example of an array of four times four ultrasonic transducers. This limitation is essentially due to the fact that the drawing is to remain simple and clear. If 16 such individual ultrasonic transducers provide too low a signal level, the array can also have more ultrasonic transducers. Therefore, the array is preferably designed with more ultrasonic transducers in a manner not illustrated. The number of ultrasonic transducers is a compromise between signal strength, complexity and costs.

The ultrasonic transducer unit 20 thus transmits and receives ultrasonic signals which move along a measurement path 24 through the pipeline 14. As shown in FIG. 1, the measurement path 24 has multiple path sections 24a, 24b, 24c.

In a first measurement, the ultrasonic transducer unit 20 transmits the ultrasonic signals along a first path section 24a of the measurement path 24 from the ultrasonic transducer unit 20 to the pipe wall 16, wherein the transit direction of the ultrasonic signals in the first measurement is indicated by solid arrows 24.1 in FIG. 1. After reflection at the pipe wall 16, the ultrasonic signals arrive along a second path section 24b from the pipe wall 16 at a reflector 30 that reflects the ultrasonic signals back along a third path section 24c to the ultrasonic transducer unit 20. The reflector 30 is arranged downstream in the direction of flow 18 of the fluid, that is after the ultrasonic transducer unit 20, on or in the pipe wall, so that the flow of the fluid in the area between the ultrasonic transducer unit 20 and the reflector 30 is disturbed only slightly or not at all, in particular if the ultrasonic transducer unit 20 is integrated flush into the pipe wall 16 (not shown).

In a second measurement, the ultrasonic transducer unit 20 transmits the ultrasonic signals in the reverse transit direction, indicated by the dashed arrows 24.2, along the third path section 24c of the measurement path 24 in the direction of the reflector 30. After reflection at reflector 30, the ultrasonic signals arrive along the second path section 24b at the pipe wall 16, from which they are reflected back along the first path section 24a to the ultrasonic transducer unit 20.

The ultrasonic transducer unit 20 and the reflector 30 are arranged such that the third path section 24c of the measurement path 24 extends between the ultrasonic transducer unit 20 and the reflector 30 at a path angle β of less than 20 degrees, preferably less than 15 degrees to the center axis 26, wherein the path angle β is indicated between the center axis 26 and the third path section 24c, here in relation to a parallel 26.1 of the center axis 26. The third path section 24c therefore extends in an area as close as possible to the pipe wall 16. Due to the flow profile 32 in the pipeline 14, the ultrasonic signal is thus only slightly influenced by the fluid flow on the third path section 24c between the ultrasonic transducer unit 20 and the reflector 30.

On the other hand, on the first path section 24a between the ultrasonic transducer unit 20 and the pipe wall 16 and on the second path section 24b between the pipe wall 16 and the reflector 30, the ultrasonic signal is strongly influenced by the flow profile 32 and the velocity of the fluid in the pipeline. As a result, the transit time of the ultrasonic signals against the flow direction measured using the second measurement (measurement path illustrated by dashed arrows) is longer than the transit time with the flow direction measured using the first measurement (measurement path illustrated by solid arrows). This allows the mean flow rate of the medium to be calculated by the evaluation of the differential transit time of both measurements.

The mean flow rate v of the fluid is calculated in this transit time method according to

$$ v = \frac{{( {L}_{24 a} + {L}_{24 b} + {L}_{24 c} )}^{2}}{2 \cdot ( {L}_{24 a} cos {α}_{24 a} + {L}_{24 b} cos {α}_{24 b} + {C}_{ν} {L}_{24 c} cos β )} \cdot \frac{{t}_{24.2} - {t}_{24.1}}{{t}_{24.1} {t}_{24.2}}$$

Here

t_{24.1} and t_{24.2} denote the sound transit times required by the emitted ultrasonic signals to cover the measurement path 24 in the first transit direction 24.1 and in the reverse transit direction 24.2;
L₂₄ₐ, L_{24b}, L_{24C} denote the lengths of the path sections 24a, 24b, 24c,
α₂₄ₐ, α_{24b} denote the path angle of the first path section 24a and the second path section 24b to the center axis 26;
β denotes the path angle of the third path section 24c to the center axis 26;
Cᵥ denotes a correction factor dependent on the flow profile and thus on the flow rate that can be determined by measurement, calibration or simulation;

With the pipe cross section and the mean flow rate v of the fluid 18, the flow can then be calculated.

The correction factor Cᵥ can be determined, for example, such that the sound transit times t_{24.1} and t_{24.2} are measured in a calibration process at one or more different predetermined mean flow rates v and the correction factor Cᵥ is calculated by rearranging the above equation. The measurement of several different flow rates is preferred, since the flow profile 32 can also depend on the flow rate. Alternatively, the correction factor Cᵥ can also be calculated by conventional simulation of the sound transit times t_{24.1} and t_{24.2} of the ultrasonic signals, taking into account a flow-rate-dependent flow profile which is likewise simulated in a conventional manner. The correction factor Cᵥ dependent on the flow profile and thus also on the flow rate can therefore be specified as a function of the sound transit times t_{24.1} and t_{24.2}.

Since the ultrasonic transducer unit 20 is designed as a phased array, the emission angle γ can be changed by controlling the individual ultrasonic transducers 22 via the control and evaluation unit 28. This can counteract a drift effect, in particular at high flow rates. In fact, the emission angle γ can be readjusted such that the reflector 30 is always struck independent of the flow rate, and the emitted ultrasonic signals are again reflected back to the ultrasonic transducer unit 20.

Due to the configuration of the ultrasonic transducer unit 20 as a phased array, the emission angle γ depends on the set phase shift of the individual signals and on the speed of sound in the fluid. The speed of sound itself is dependent on ambient conditions such as temperature and pressure. Therefore, it is advantageous for the phase difference to be adapted as a function of the ambient conditions via the control of the individual ultrasonic transducers 22 by means of the control and evaluation unit 28 in such a way that the emission angle γ remains the same, even if the speed of sound changes. To determine the ambient conditions, an environment detection unit (not shown) can be provided, which detects, for example, temperature and/or pressure in the pipeline 14 and forwards it to the control and evaluation unit 28 in order to monitor the fluid properties and thus calculate the sound velocity and density. With this knowledge, the ultrasonic transducers 22 can be better controlled or evaluated. The density is necessary to calculate the mass flow and can be calculated from the properties of the medium as well as temperature and pressure. The sound velocity itself can be measured initially using known ambient conditions, fluid at rest and known length of the measurement path by measuring a transit time for both transit directions of the ultrasonic signal along the measurement path, determining a mean transit time therefrom and dividing the length of the measurement path by the mean transit time:

$$c = \frac{L}{\frac{( {t}_{1} + {t}_{2} )}{2}}$$

### Where:

c=sound velocity
L=length of the measurement path
t₁=transit time of the ultrasonic signal along the measurement path in the first direction
t₂=transit time of the ultrasonic signal along the measurement path in the second direction

The measurement path 24 is illustrated in FIG. 1 as a diametrical measurement path extending through a center axis 26 of the pipeline 14. According to the invention, it can be designed as a secant path, as shown in FIG. 3.

FIG. 3 shows an embodiment of a flowmeter 310 according to the invention, wherein the pipeline 14 is illustrated in the flow direction. The ultrasonic transducer unit 20 emits ultrasonic signals on a measurement path 34, which now does not extend diametrically through the center axis 26 of the pipeline 14, but rather as a so-called secant path with the path sections 34a, 34b, 34c. In addition, as in the example of FIG. 1, the measurement path 34 does not extend orthogonally to the flow direction 18, that is, out of the drawing plane or into the drawing plane. The use of secant paths is advantageous for asymmetrical velocity distributions. Since the path sections 34a, 34b, 34c of the measurement path 34 do not extend through the center axis 26 of the pipeline 14, the center axis 26 of the pipeline 14 does not lie in a measurement plane spanned by the path sections 34a, 34b, 34c of the measurement path 34, but only intersects it at one point. In this way, higher accuracies are possible in the determination of the mean flow rate. To reasonably scan the flow profile, it can be true for at least one path section that the ratio r/R is between 0.3 and 0.65, wherein R is the radius of the pipeline and r is the shortest distance of the path section to the center axis of the pipeline, shown here for the path section 34a. Preferably, a multi-path measurement can take place, wherein the ultrasonic transducer unit 20 emits ultrasonic signals at different angles, so that the ultrasonic signals pass through the pipeline 14 on different measurement paths within a measurement plane, wherein a reflector 30 can be arranged on or in the pipe wall for each measurement path.

FIG. 4 shows a perspective view of an embodiment of a flowmeter 410 according to the invention with an ultrasonic transducer unit 20 having a two-dimensional array of individually controllable ultrasonic transducers and capable of transmitting and receiving ultrasonic signals in different measurement planes. By way of example, three different measurement paths 432, 434, 436 are illustrated with path sections 432a-c, 434a-c, 436a-c. The measurement paths 432, 434, 436 are secant paths that do not extend diametrically through the center axis 26 of the pipeline 14. The center axis 26 of the pipeline 14 therefore does not lie in the measurement planes spanned by the measurement paths 432, 434, 436, but only intersects each of them at one point. For the sake of clarity, the transit direction of the measurement signals is not illustrated along the measurement paths 432, 434, 436, but also here, as in the examples shown previously, the measurement signals each extend through the measurement paths 432, 434, 436 in both directions, that is, for example for the measurement path 432 in a first measurement, initially along path section 432a from the ultrasonic transducer unit 20 to the pipe wall 16, then along the path section 432b to the reflector 430 and from the reflector 430 along the path section 432c back to the ultrasonic transducer unit 20. In a second measurement, the measurement path 432 is then passed through in the reverse direction, that is, first along path section 432c from the ultrasonic transducer unit 20 to the reflector 430, then along the path section 432b to the pipe wall 16 and along path section 432a from the pipe wall 16 back to the ultrasonic transducer unit 20.

Instead of individual reflectors, this exemplary embodiment has a reflector 430 arranged in an arc shape on or in the pipe wall. Since the ultrasonic transducer unit 20 is designed as a two-dimensional ultrasonic transducer unit, it can emit and receive these ultrasonic signals in different measurement planes and can be controlled so that the ultrasonic signals strike the reflector 430 at different locations. As a result, different measurement paths and/or measurement planes can be used flexibly. The reflector 430 can also be designed circular, that is, it covers the entire inner circumference of the pipe wall, whereby the number of possible measurement paths is further increased.

In principle, the use of several ultrasonic transducer units is also possible for a multipath measurement, as shown in FIG. 5. In addition to a first ultrasonic transducer unit 20/1 that emits and receives ultrasonic signals along a measurement path 24/1, wherein the ultrasonic signals is reflected at a first reflector 30/1, the flowmeter 10 has a second ultrasonic transducer unit 20/2 that emits and receives ultrasonic signals along a second measurement path 24/2, wherein the ultrasonic signals are reflected at a second reflector 30/2. Depending on the accuracy requirement for the flow measurement, a plurality of N ultrasonic transducer units can be used that span N measurement paths. Instead of N reflectors, a reflector can then also be provided, for example, which is designed as a circumferential elevation or groove of the pipe wall 16.

In each of the exemplary embodiments shown in FIG. 3 and FIG. 4, a simple reflection of the ultrasonic signals occurs at the pipe wall 16. To further increase the measurement accuracy, the measurement paths 34, 432, 434, 436 can also be designed such that the ultrasonic signals between the ultrasonic transducer unit 20 and the reflector 30, 430 are reflected several times on the pipe wall 16. Preferably, the path sections 34c, 423c, 434c, 436c, on which the ultrasonic signals arrive directly, that is, without reflection at the pipe wall 16, from the reflector 30, 430 at the ultrasonic transducer unit 20 (or in the reverse transit direction from the ultrasonic transducer unit 20 directly at the reflector) as explained above, in an area close to the pipe wall 16.

To further reduce the influence of the fluid flow on the ultrasonic signals extending directly between ultrasonic transducer unit 20 and reflector 30, these can be shielded from the fluid flow by various embodiments, which are shown in the following FIGS. 6a-6c.

FIG. 6a shows a mechanical shield 40, 42, which essentially houses the area between the ultrasonic transducer unit 20 and the reflector 30, and has only openings for entry and exit of the ultrasonic signals.

FIG. 6b shows an alternative embodiment in which the ultrasonic transducer unit 20 and the reflector 30 are arranged in a recess 44 of the pipe wall.

For further shielding, the recess 44 can be closed, as shown in FIG. 5c, except for openings for entry and exit of the ultrasonic signals, comparable to the exemplary embodiment in FIG. 5a. The indentation 44 can also be configured as a measurement module that can be flanged to an opening in the pipe wall 16 and includes the ultrasonic transducer unit 20 and the reflector 30.

Another alternative embodiment of the invention is shown in FIG. 7. The ultrasonic transducer unit 20 emits and receives ultrasonic signals that move along a measurement path 64 through the pipeline 54. As in the previous exemplary embodiments, the measurement path 64 has a plurality of path sections 64a, 64b, 64c.

In contrast to the exemplary embodiments in FIG. 3, the reflector 60 is formed for reflecting back the ultrasonic signals through the pipe wall 56 of the pipeline 54 itself. The pipeline 54 has a u-shaped winding.

In a first measurement, the ultrasonic transducer unit 20 emits the ultrasonic signals along a first path section 64a of the measurement path 64, wherein the transit direction of the ultrasonic signals during the first measurement is denoted by solid arrows 64.1. After a reflection at the pipe wall 56, the ultrasonic signals pass along a second path section 64b to a reflector 60, which is formed by the pipe wall 56 and reflects the ultrasonic signals back along a third path section 64c to the ultrasonic transducer unit 20.

In a second measurement, the ultrasonic transducer unit 20 emits the ultrasonic signals in reverse transit direction, characterized by the dashed arrows 64.2, along the third path section 64c of the measurement path 64 in the direction of the reflector 60. After reflection at the reflector 60, the ultrasonic signals pass along the second path section 64b to the pipe wall 56, from which they are reflected back along the first path section 64a to the ultrasonic transducer unit 20.

Due to the u-shaped geometry of the pipeline 54, the measurement path 64 extends through the fluid 18 such that the third path section 64c extends essentially parallel to the flow of the fluid 18, while the other two path sections 64a, 64b extend essentially perpendicular to the flow of the fluid 18. Thus, the propagation speed of the ultrasonic signals on the first and second path sections 64a, 64b is influenced only slightly by the fluid flow.

On the third path section 64c between ultrasonic transducer unit 20 and reflector 60, the ultrasonic signal is strongly influenced by the fluid flow and the velocity of the fluid in the pipeline 54. As a result, the transit time of the ultrasonic signals against the flow direction measured using the second measurement (measurement path illustrated by dashed arrows) is longer than the transit time with the flow direction measured using the first measurement (measurement path illustrated by solid arrows). Thus, with this embodiment of the invention as well, it is possible to calculate the mean flow rate of the fluid 18 via the evaluation of the differential transit time of both measurements.

1. A device for measuring a flow of a fluid (18), having
a sensing element (12) having a pipeline (14) for the fluid (18) with a pipe wall (16),
at least one phased array ultrasonic transducer unit (20) that can emit ultrasonic signals into different emission angles (γ) and can receive ultrasonic signals from different reception angles (ϕ)
a control and evaluation unit (28) that is designed for controlling the ultrasonic transducer unit (20) for emitting the ultrasonic signals along a measurement path (34, 432, 434, 436, 64) and for evaluating the received ultrasonic signals and determining a flow using transit times of the ultrasonic signals,
wherein the sensing element (12) has at least one reflector (30, 430, 50) that is designed to reflect the ultrasonic signals emitted by the ultrasonic transducer unit (20) back to the same ultrasonic transducer unit (20), wherein the ultrasonic signals pass through the measurement path (34, 432, 434, 436, 64) from the ultrasonic transducer unit (20) to the reflector (30, 50) and back to the ultrasonic transducer unit (20) on at least three different path sections (34a-c, 432a-c, 434a-c, 436a-c, 64a-c),
characterized in that
the measurement path (34, 432, 434, 436, 64) is a secant path not extending diametrically through a center axis (26) of the pipeline (14).

2. The device according to claim 1, characterized in that the control and evaluation unit (28) is designed to control the ultrasonic transducer unit (20) such that the ultrasonic signals in a first transit time measurement pass through the measurement path (34, 64) in a first direction (34.1, 64.1) and in a second transit time measurement in a second direction (34.2, 64.2) opposite to the first direction, and to determine a mean flow rate (v) of the fluid (18) from a difference in the transit time measurements.

3. The device according to claim 1, characterized in that the ultrasonic transducer unit (20) is integrated in the pipe wall (16).

4. The device according to claim 1, characterized in that the ultrasonic transducer unit (20) is designed as a two-dimensional array of ultrasonic transducers (22).

5. The device according to claim 1, characterized in that the ultrasonic transducer unit (20) is designed as a one-dimensional array, wherein a received ultrasonic signal has an angle with respect to a nominal transmitting and receiving plane of the ultrasonic transducer unit (20) that is at most as large as an acceptance angle of the ultrasonic transducer unit (20).

6. The device according to claim 5, wherein a magnitude of the acceptance angle is less than 10 degrees.

7. The device according to claim 1, characterized in that a path section (34c, 432c, 434c, 436c) of the measurement path (34, 432, 434, 436) lying between reflector (30) and ultrasonic transducer unit (20) extends at a path angle (β) of less than 20 degrees, preferably less than 15 degrees, to the center axis (26) of the pipeline (14).

8. The device according to claim 1, characterized in that the ultrasonic transducer unit (20) is oriented such that the ultrasonic signals are emitted at emission angles (γ) and incidence angles (ϕ) that are equal in magnitude and are received again after passing through the measurement path (34, 432, 434, 436).

9. The device according to claim 1, characterized in that the control and evaluation unit (28) is designed to control the ultrasonic transducer unit for tracking the emission angle (γ) as a function of the mean flow rate (v) of the fluid (18).

10. The device according to claim 1, characterized in that for at least one path section (34a-c), a ratio r/R is between 0.3 and 0.65, wherein R is the radius (R) of the pipeline (14) and r is the shortest distance (r) of the path section (34a-c) to the center axis (26) of the pipeline (14).

11. The device according to claim 10, characterized in that at least two path sections (34a-c) have a different ratio r/R.

12. A method for measuring a flow of a fluid (18) flowing in a pipeline (14), comprising the steps of:
emitting ultrasonic signals along a measurement path (24, 34, 64) in the pipeline (14) with a phased array ultrasonic transducer unit (20) controlled by a control and evaluation unit (28)
receiving the emitted ultrasonic signals with the same ultrasonic transducer unit (20) after passing through the measurement path (24, 34, 64).
evaluating the received ultrasonic signals and determining a flow of the fluid (18) using transit times of the ultrasonic signals with the control and evaluation unit (28)
wherein the ultrasonic signals emitted by the ultrasonic transducer unit (20) are reflected back by at least one reflector (30) to the ultrasonic transducer unit (20), wherein the ultrasonic signals pass through the measurement path (34, 432, 434, 436, 64) from the ultrasonic transducer unit (20) to the reflector (30, 430, 50) and back to the ultrasonic transducer unit (20) on at least three different path sections (34a-c, 432a-c, 434a-c, 436a-c, 64a-cc),
characterized in that
the measurement path (34, 432, 434, 436) is a secant path that is not diametrically extending through a center axis (26) of the pipeline (14).

13. The method according to claim 12, characterized by the further steps of:
emitting the ultrasonic signals in a first measurement such that the ultrasonic signals pass through the measurement path (34, 64) in a first transit time measurement time in a first direction (34.1, 64.1) and in a second transit time measurement in a second direction (34.2, 64.2) opposite to the first direction, and
determining a mean flow rate (v) of the fluid (18) from a difference of the first and second transit time measurements.
